(19) United States
(12) Patent Application Publication
(10) Pub. No.: US 2025/0248407 A1
(43) Pub. Date: Aug. 7, 2025

(54) SYSTEM AND METHOD FOR PREPARING FOOD AUTONOMOUSLY

(71) Applicant: HYPER FOOD ROBOTICS LTD., Tel Aviv (IL)

(72) Inventors: Harel David SHAFRAN, Nir Tzvi (IL); Yariv Zvi RECHES, Ramat Gan (IL); Yehuda SHAMAI, Tel Aviv (IL)

(21) Appl. No.: 18/856,617

(22) PCT Filed: Apr. 14, 2023
(86) PCT No.: PCT/IL2023/050397

§ 371 Date: Oct. 13, 2024

Related U.S. Application Data
(60) Provisional application No. 63/330,784, filed on Apr. 14, 2022.

(51) Int. Cl. A21C 9/04; A21B 3/07; A47J 44/00

(52) U.S. Cl. CPC A21C 9/04; A21B 3/07; A47J 44/00

(57) ABSTRACT

A system for preparing pizza, comprising a dough storing section configured to store dough to be used for preparing the pizza; a management system configured to manage the storage and preparation processes of the dough in the dough storing section; a stretching machine for stretching the pizza dough; a dough moving system configured to move the dough from the dough storing section to the stretching machine; a topping-storing section configured to store toppings to be dispensed on the dough; a dispensing system configured to dispense toppings on the dough; topping moving system configured to move toppings from the topping storing section to the dispensing system; one or more collection compartments for storing the pizza after the pizza is prepared for delivery.

### FIELD OF THE INVENTION

The present invention relates to an autonomous system for preparing food and methods for utilizing it.

### BACKGROUND OF THE INVENTION

The concept of restaurants as a place for providing meals or cooked food for people has been known for centuries. Cooked food is defined as food ready to be consumed by the end-user, after being fried, baked, mixed, heated, boiled, or otherwise prepared.

Restaurants provide a cultural experience, in which the customers have to go to a certain place, dress nicely, and be served by waiters. This may take more time than required by the customers, and incur additional costs, such as transportation. In addition, it is fairly expensive to operate a restaurant in a central location, in terms of rental payments, indoor design, labor costs, and the like. Therefore, there is a mutual benefit for both customers and restaurant owners to transfer some of the traffic to delivery. One should remember that the restaurant's income is limited by its size, while the delivery is limited by the staff's ability to produce food, which is much higher and flexible. Staff's capacity to produce cooked food has been extended in recent years through the development of ghost kitchen (also known as a delivery-only restaurant, virtual kitchen, shadow kitchen, commissary kitchen, or dark kitchen), which is a professional food preparation and cooking facility set up for the preparation of delivery-only meals.

Yet, ghost kitchens require people to prepare cooked food, which becomes a significant cost component. In addition, the kitchen's managers cannot accurately tell the exact number of cooks required each day/shift to provide the cooked food, which reduces the efficiency and profit of the ghost kitchen.

### SUMMARY OF THE INVENTION

The subject matter discloses a system for preparing pizza, comprising a dough storing section configured to store dough to be used for preparing the pizza; a management system configured to manage the storage and preparation processes of the dough in the dough storing section; a stretching machine for stretching the pizza dough; a dough moving system configured to move the dough from the dough storing section to the stretching machine; a topping-storing section configured to store toppings to be dispensed on the dough; a dispensing system configured to dispense toppings on the dough; topping moving system configured to move toppings from the topping storing section to the dispensing system; one or more collection compartments for storing the pizza after the pizza is prepared for delivery.

In some cases, the dough storing section comprises a compartment for frozen dough and a compartment for chilled dough. In some cases, the dough storing section comprises a compartment for proofing the dough.

In some cases, the system further comprises a dough extracting system configured to enable a dough extractor to open a specific compartment in the dough-storing section.

In some cases, the system further comprises a topping extracting system configured to enable a topping extractor to open a specific compartment in the topping-storing section.

In some cases, the system further comprises a dispenser actuator configured to grip the plate and to move the plate that carries the dough when the plate is located under the topping dispenser.

In some cases, the system further comprises a plate conveyor for conveying the plate to the plate-removing unit. In some cases, the system further comprises a plate cleaning station for cleaning the plate. In some cases, the plate cleaning station is configured to clean the plate when located on a plate conveyor. In some cases, the plate cleaning station comprises a brush and a pressurized gas dispenser. In some cases, the plate cleaning station comprises arms for centering plates of various sizes

In some cases, the system further comprises a packing arm configured for collecting a pizza package from a stack of pizza packages, partially folding the pizza package, placing the pizza in a package, and fully folding the pizza package with the pizza inside the pizza package. In some cases, the dispensing system comprises multiple dispensing heads, each of the dispensing heads comprises an outlet for dispensing the toppings and an inlet for receiving the toppings.

In some cases, the system further comprises cleaning tubes configured to emit fluids into the dispensing heads, said fluids are used to clean the dispensing heads. In some cases, the system further comprises an actuator for moving the dispensing heads away from the cleaning tubes.

In some cases, the at least one dispensing head of the multiple dispensing heads is configured to dispense sliced toppings, wherein the dispensing system further comprises a topping slicer coupled to the at least one dispensing head for cutting the sliced topping when the sliced topping is placed at the at least one dispensing head.

In some cases, the system further comprises multiple box storages for receiving content from a box collected from the topping-storing section, wherein each box storage is fluidly coupled to one of the multiple dispensing heads, such that content is transferred from the box storages to the dispensing heads.

In some cases, the dispensing system comprises a dispensing weight sensor configured to detect a weight of a topping in a dispensing head and verify the amount of topping dispensed onto the dough.

In some cases, the stretching machine is configured to prepare the dough in a form of complicated pizza types. In some cases, the dispensing system comprises a topping weight sensor configured to detect a weight of a topping in a container and electronic circuitry configured to send a command to the topping conveyor to convey a new batch of toppings when the weight is lower than a threshold.

In some cases, the system further comprises a delivery preparation system for preparing the pizza for delivery. In some cases, the delivery preparation system receives the pizza after preparation by cooking equipment, and prepares the pizza for delivery, before sending the pizza to the collection compartments. In some cases, the delivery preparation system comprises a knife for cutting the pizza. In some cases, the delivery preparation system comprises a bundling arm for packing multiple pizzas in a single package.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a perspective view of an autonomous system for preparing a pizza, according to exemplary embodiments of the present invention;

FIGS. 2A-2C schematically show cartridges located in the makeline area of the autonomous system, according to exemplary embodiments of the present invention;

FIG. 3 schematically shows a knife and a knife housing, according to exemplary embodiments of the present invention;

FIG. 4 schematically shows a collection compartment of the autonomous system, according to exemplary embodiments of the present invention;

FIGS. 5A-5C schematically show a cartridge body, cartridge seating, and a dispensing head of the autonomous system, according to exemplary embodiments of the present invention

FIG. 6 shows a storage area for storing and managing processes of pizza dough, according to exemplary embodiments of the subject matter.

FIG. 7 shows a machine for stretching pizza dough used for one or more pizza types, according to exemplary embodiments of the subject matter.

FIG. 8 shows a method for processing doughs in the autonomous system, according to exemplary embodiments of the subject matter.

FIG. 9 schematically shows a dispensing head for dispensing content, according to exemplary embodiments of the present invention.

FIG. 10 shows a method for providing a new batch of toppings to the dispensing system, according to exemplary embodiments of the subject matter.

FIG. 11 shows a topping and sauces storage system, according to exemplary embodiments of the subject matter.

FIG. 12 shows a gantry-like system for extracting content from the topping and sauces storage system, according to exemplary embodiments of the subject matter.

FIG. 13 shows a collector for extracting content from the topping and sauces storage system, according to exemplary embodiments of the subject matter.

FIGS. 14A-14B show a dispensing system for dispensing toppings and sauces onto the dough, according to exemplary embodiments of the subject matter.

FIGS. 15A-15B show a dispensing system for dispensing sliced content, according to exemplary embodiments of the subject matter.

FIG. 16 shows a system for transferring plates from an area in which the pizza is already prepared to the pizza preparation area, according to exemplary embodiments of the subject matter.

FIG. 17 shows a system for transferring plates from an area in which the pizza is prepared to the pizza preparation area, according to exemplary embodiments of the subject matter.

FIG. 18 shows a system for dispensing oil onto the plates in an autonomous pizza preparation system, according to exemplary embodiments of the subject matter.

FIGS. 19A-19B schematically show a folding arm for folding a package of a prepared pizza, according to exemplary embodiments of the present invention;

FIG. 20 shows a method for folding a package, according to exemplary embodiments of the subject matter.

### DETAILED DESCRIPTION OF THE INVENTION

The subject matter discloses an autonomous system for preparing pizza. The system comprises ingredients tanks that contain the ingredients of the pizza, heating and cooking equipment for preparing the pizza from the ingredients, a computerized unit for controlling the cooking and delivering process, and robotic units for moving objects in the system from one place to another. The ingredients tanks may move based on the system's requirements, for example toward the heating/cooking units. In some other cases, the ingredients tanks may remain in place during cooking and robotic arms may move towards the ingredients tanks to extract or collect the ingredients. The ingredients tanks may include cartridges that have an opening from which the ingredients are dispensed upon command. The ingredients tanks may include cabinets storing other ingredients.

The autonomous system of the subject matter may also comprise a delivery preparation system for preparing the pizza for delivery. The delivery preparation system receives the pizza after preparation by the cooking equipment, and prepares the pizza for delivery, before sending the pizza to the collection compartments. For example, the delivery preparation system comprises a packing arm for packing the pizza. The delivery preparation system may also include a knife for cutting the pizza, for example slicing a pizza. The delivery preparation system may also comprise a bundling arm for packing multiple pizzas in the same package. The delivery preparation system may also comprise quality control sensors, such as image capturing devices for capturing images of the pizza to verify that the pizzas were prepared properly, metal sensors, and the like.

The system is designed to be placed as an entire store, executing the entire supply chain of a restaurant autonomously, from receiving the order, cooking the pizza included in the order, and providing the order to a customer or a delivery person. The system comprises a housing, for example in the shape of a cube or a box. The housing comprises a base, functioning as a floor, sidewalls, and a ceiling. The housing comprises a passage for coupling the system's components with infrastructures, such as electrical grid, water, drainage, communication network, and the like. The housing also comprises an input opening in which the ingredients are provided into the ingredients tanks. The ingredients' tanks may be provided in the same shape and size for various toppings and sauces, to enable dispensing heads to dispense different types of toppings. A cartridge may include multiple boxes, each box may store a different topping or ingredient. The housing also comprises a collection opening, in which the customer or delivery person collects the pizza.

The term “autonomous” is defined in the subject matter as self-governing, that does not require persons to operate. This is different from automated, which performs a process, but still requires persons to operate it.

The autonomous system cooks the pizza from the ingredients of the pizza, the ingredients are stored in the system's ingredients tanks in a cooled state, or a frozen state, in a temperature range of −18-10 degrees Celsius, more specifically about −18 to 4 degrees Celsius.

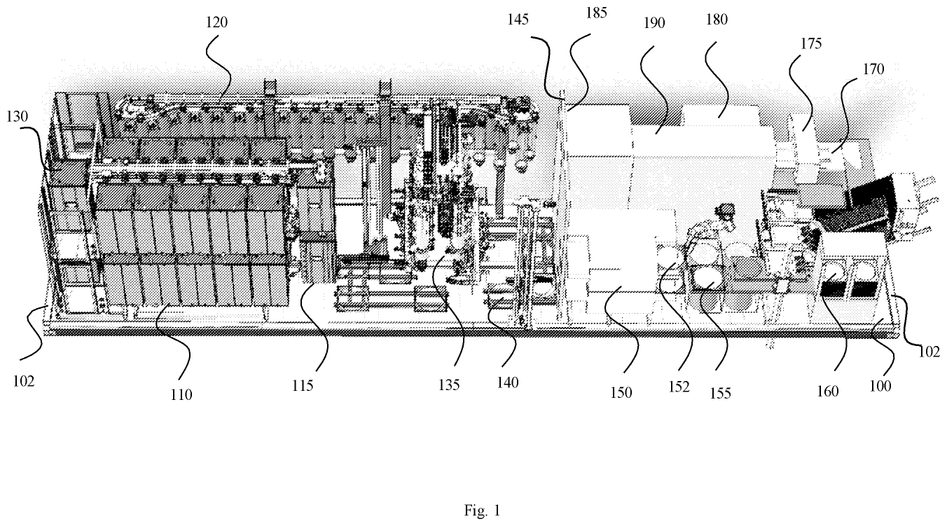

FIG. 1 shows a perspective view of an autonomous system for preparing a pizza, according to exemplary embodiments of the present invention.

The perspective view does not show the sidewalls and ceiling of the housing, only the floor 100. The edges 102 of the floor 100 define the walls from which the sidewalls extend upwards. The volume defined inside the housing is divided into at least two (2) sub-areas defined by a wall 145 or another barrier that prevents the passage of cold air from the cooled sub-area to the non-cooled area. The cooled area comprises the first array of ingredients tanks 110 and the second array of ingredients tanks 120, both containing the ingredients used to cook the pizza, or dishes, per the orders received in the system. The first array of ingredients tanks 110 may be implemented in the form of cabinets having doors. When wishing to use the ingredients from the ingredients tanks 110, the relevant cabinet is moved towards the makeline 135. The cooled area may also include the makeline 135, which is where the pizza is assembled from the ingredients. In some other cases, the makeline 135 is located in the non-cooled area. The cooled area also comprises the loading area 130. The loading area may span in one of the ends of the housing, to enable filling the ingredients tanks in a minimally invasive manner, for example by opening a door or a window in the housing sidewall, and accessing the ingredients tanks to be filled.

The loading process is performed by a person delivering the ingredients to the autonomous system. The supplying person then opens the input aperture in one of the sidewalls of the system's housing. In some exemplary cases, each of the arrays of ingredients tanks 110, 120 have at least one ingredients tank accessed from the loading area 130. So, the supplying person fills the cabinet or cartridge accessed to him/her or replaces a cartridge. In some exemplary cases, the loading area 130 is equipped with cleaning or sterilization devices for sterilizing the new ingredients tanks loaded into the system. The cleaning or sterilization devices may dispense pressurized gas or cleaning fluid on the loaded ingredients tanks. In some cases, when loading a new cabinet into the system, the new cabinet may be placed on a movable platform. The platform moves upwards when the person loading the new cabinet opens the aperture in the housing to insert the new cabinet therein. Once the new cabinet is located on the platform, the platform moves downwards and the new cabinet is secured to the cabinet main bar.

After the first ingredients tank is full, the array of ingredients tanks moves to place another ingredients tank in a position accessed from the loading area 130. In some cases, there is one cabinet and one cartridge always present in the loading area 130. The computerized unit governing the operation of the autonomous system receives an indication as to the ingredients inputted into the ingredients tanks. Such information may be inputted by the supplying person into an electronic device. In other cases. The ingredients are secured to a plate having an RFID tag that identifies the type of ingredient just inserted into an ingredients tank, or to a specific shelf in a cabinet, as in the first array of ingredients tanks 110. In the second array of ingredients tanks 120, the indication may be provided by a weight sensor detecting the weight on each cartridge and communicating with the computerized unit.

The makeline 135 comprises one or more moving arms and conveyors for preparing the pizza. For example, in case the pizza is a pizza plate, the arms extract the pizza dough from a specific cabinet of the first array of ingredients tanks 110, and move the dough under relevant cartridges in the second array of ingredients tanks 120, to spread sauces and add toppings. The arms of the makeline 135, and the arrangement of the cartridges in the second array of ingredients tanks 120, enable to pour sauce, cheese, and toppings on multiple doughs concurrently. After the dough is covered with toppings and sauces according to the order, the arm moves the dough to a pre-oven area 140, coupled to a conveyor. The conveyor moves the dough to an oven 150.

The dough may be stored in the cabinets in the form of pizza (for example, relatively flat, and having a round cross-section), and ready for baking. In some other cases, the dough may be provided in the form of a disc, not ready for baking. In such a case, the disc undergoes a thawing process, for example for 24 hours at 4 degrees Celsius. Then, the dough is ready for preparation. The preparation comprises placing the disc on an oiled pan and opening the disc. The disc may be provided into the system in a frozen state, in a condition of fewer than 0 degrees Celsius, or a cooled state, for example in the range of −15-20 degrees Celsius.

In some cases, an oven lift is used to raise the dough from the conveyer to the height of the oven 150. The oven is located in the non-cooled area, on the other side of the wall 145. The oven may be a conveyor oven, moving the cooked pizza to a resting area 152. During the entire process of storing the dough, adding the sauce and toppings, and baking the pizza, the dough is located under a plate. After cooking in the oven 150, a packing arm removes the pizza from the plate and places the pizza on a box in a packaging area 155. The plate is moved by the packing arm to a stack of plates 160. The cooked pizza is cut into slices and covered by the box by the packing arm. The packing arm then moves the box with the cooked pizza on a collection conveyor 170 that conveys the box towards the collection compartment 190 where the box is to be collected.

The pizza may be conveyed on the collection conveyor 170 through a sensor 175 to verify the pizza's quality, such as a metal sensor configured to verify that the pizza lacks metallic materials. In some cases, the pizza is packed and collected before it's baked in the oven.

The pizza is then conveyed to a heated area 180 where the pizza is stored before collection. The heated area may be heated to a temperature of 50-80 degrees Celsius. The system also comprises a cold dish storage 185 for storing cooled dishes, such as beverages, desserts, salads, and the like. The cold dish storage 185 may store the cooled items in a temperature range of 4-10 degrees Celsius. The autonomous system also comprises collection compartments 190 enabling a person to collect the pizza from outside the housing. The collection compartments 190 may have two lateral passageways-one for conveying pizza from the heated area 180 and the other for conveying cooled items from the cold dish storage 185. The collection compartments 190 also comprise an external passageway, directed outside of the housing, enabling a person to remove the pizza from the collection compartments 190.

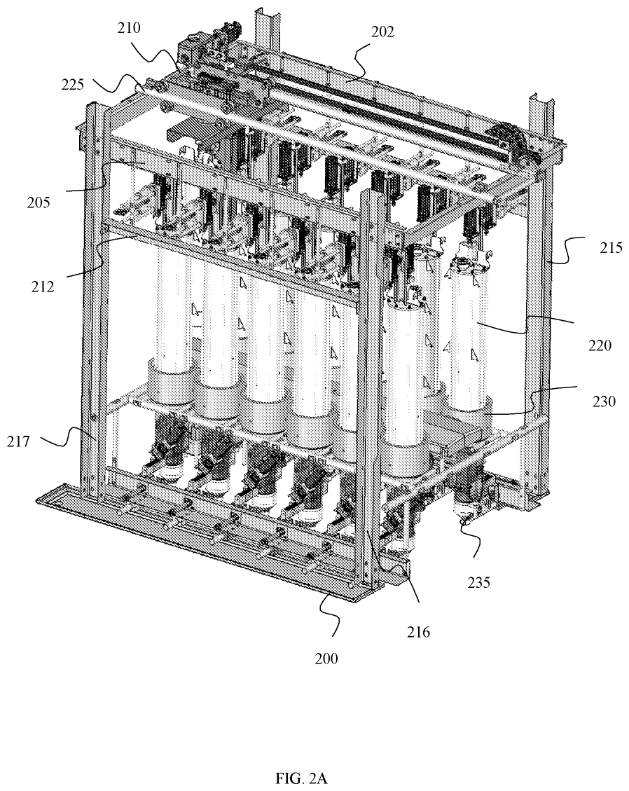

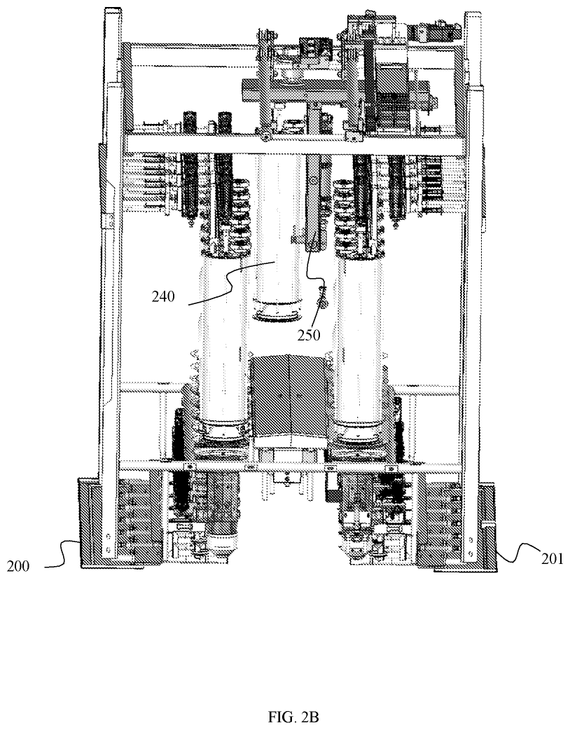

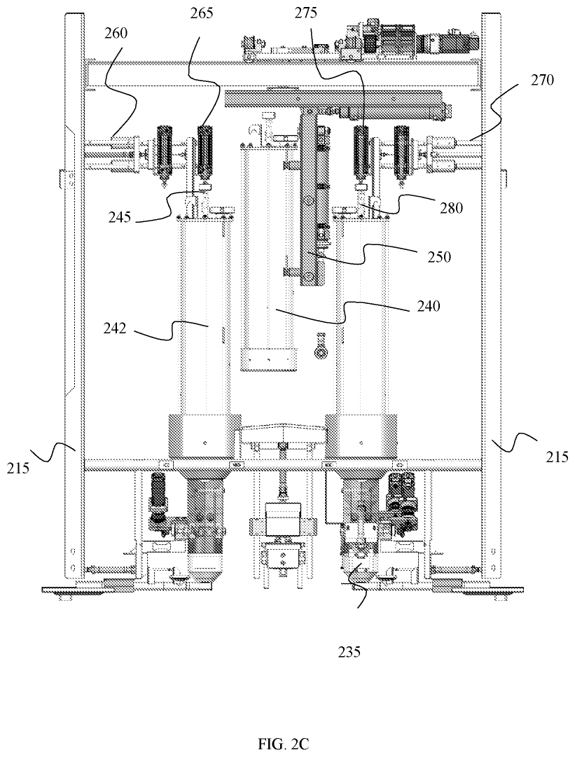

FIGS. 2A-2C show a first array of movable cabinets and a fetching mechanism for extracting the ingredients from the ingredients tanks, according to exemplary embodiments of the present invention. The first array of ingredients tanks includes cabinets that store ingredients required to be extracted from the ingredients tanks.

The ingredients in the first array of ingredients tanks may be stacked one on top of the other. In other cases, the cabinets of the first array of ingredients tanks comprise shelves enabling the supplying person to place the ingredients on the shelves, for example using plates or trays.

FIGS. 2A-2C schematically show cartridges located in the makeline area of the autonomous system, according to exemplary embodiments of the present invention. The cartridges in the makeline area may be placed on a cartridge frame. The cartridge frame comprises a frame base having two distinct surfaces 200. In some cases, the frame base comprises a single base surface. The cartridges are mounted on two horizontal bars 202 and 205. The horizontal bars 202 and 205 to vertical poles such as poles 215, 216, 217. The poles extend from the base surfaces 200, 201. Each cartridge comprises a cartridge body 220 that contains the ingredients, a cartridge seating 230 and a cartridge dispenser 235. The cartridge bodies are mounted on cartridge bars, such as cartridge bar 212, coupled to the cartridge frame. The cartridge body 220 is removeable from the cartridge seating 230, to enable replacing the cartridges according to the content required to prepare the pizza. The ingredients contained in the cartridge body 220 are poured via the cartridge dispenser 235. For example, the arms move the tray under the cartridge dispensers to cover the areas according to the specification of the desired pizza. In some cases, the cartridge dispenser 235 is a separate unit from the cartridge body 220 and from the poles 215, 216, 217 that carry the cartridge bodies 240, 242. This way, the heavy cartridge bodies do not “sit” on top of the cartridge dispenser 235, enabling to accurately weigh the cartridge dispenser 235 and verify that the amount of material dispensed from the cartridge dispenser 235 is accurate.

FIG. 2B shows the two base surfaces 200, 201 and a cartridge body 240 removed from the horizontal bar. When replacing a cartridge body, a carrier 250 moves along a carrier bar 225 towards the replaced cartridge body 240. The carrier bar 225 may be coupled to the cartridge frame. When the carrier 250 arrives at the replaced cartridge body 240, the carrier moves the cartridge body 240 upwards, to release the cartridge body 240 from the cartridge seating 230. The cartridge body 240 may be of a cylindrical shape, or may have a polygonal cross section, or any other shape desired by a person skilled in the art. The cartridge body 240 may comprise protrusions in an external surface thereof, such that the carrier 250 grasps the cartridge body 240 from the protrusions. After the upward movement of the cartridge body 240, the carrier 250 moves the cartridge body 240 towards the cartridge waiting bar. The cartridges in the waiting area may move along a conveyor coupled to the cartridge waiting bar. Then, the carrier 250 can place another cartridge body from the waiting bar to the makeline bar.

FIG. 2C shows a pusher 265 being in physical content with an upper end 245 of the cartridge body 242. When there is need to dispense content form the cartridge body 242, the pusher 265 moves downwards, pressing on an item inside the cartridge body 242, resulting in content dispensed from the cartridge dispenser 235. When there is a need to replace the cartridge body 242, the pusher 265 moves away from the upper end 245. For example, the pusher 265 may move towards the pole 215.

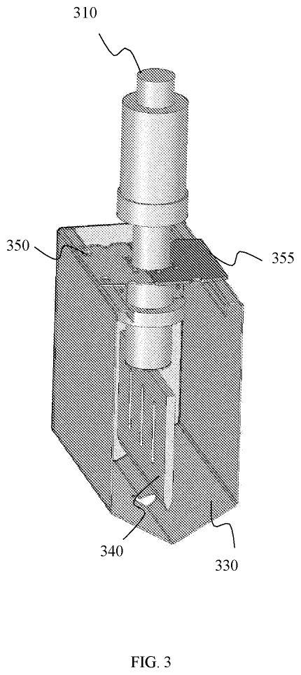

FIG. 3 schematically shows a knife and a knife housing, according to exemplary embodiments of the present invention. The knife may comprise a knife handle located inside a knife housing. At least a portion of the knife handle comprises a niche, groove or a protrusion, enabling a robotic arm to secure the knife handle thereto.

FIG. 3 also shows an internal surface 330 of the knife housing and the knife 340. The knife 340 is coupled to the knife handle 310. The knife 340 may be an ultrasonic knife, emitting ultrasonic signals to cut items. The properties of the ultrasonic signals may vary according to the items but by the knife 340. The knife housing may have a housing cover having multiple cover parts 350, 355. The cover parts 350, 355 are movable, for example moving rotationally upwards and outwards from the knife housing 320 when the knife 340 is moved out of the knife housing. The cover parts 350, 355 may form a void in the shape and size of the knife handle, such that when placing the knife 340 in the knife housing, the knife 340 remains substantially perpendicular to the surface of the housing cover. The knife housing may have a cleaning system that enables cleaning the knife 340 while the knife 340 is in the knife housing.

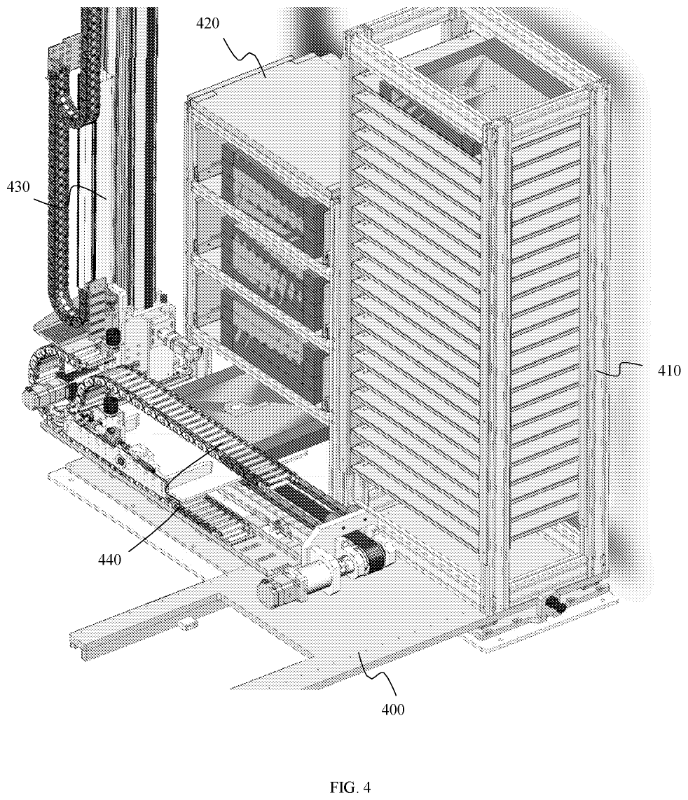

FIG. 4 schematically shows a collection area of the autonomous system, according to exemplary embodiments of the present invention. The collection area comprises collection section 420 having multiple collection compartments used to store the orders ready to be delivered. The collection section 420 is located near heated area 410, where the prepared pizzas are stored after prepared for delivery. The collection area may also comprise a cold dish storage used to store cooled items, such as beverages and deserts. The collection area may be placed on a collection base 400. The collection base 400 may be part of the system's base, or may be placed on top of the system's base. The collection area comprises a conveyor 440 used to convey pizza. For example, to convey pizza from the heated area 410 to the collection section 420 when the delivery person reaches the system to collect the order.

The conveyor 440 may be coupled to a collection lift 430. The collection lift 430 is coupled to a shelf, the shelf receives the prepared pizza which was stored in the heated area 410 and places the prepared pizza in the relevant collection compartment of the collection section 420. The collection lift 430 receives the prepared and packed pizza and places it on the shelf, which places the packed pizza in the specific collection compartment associated with the order that contains the pizza. The specific collection compartment may be provided by the management system. The collection compartments may be stacked one on top of the other. The management system sends a command to the lift, the command comprising the height needed for the specific collection compartment associated with a specific order.

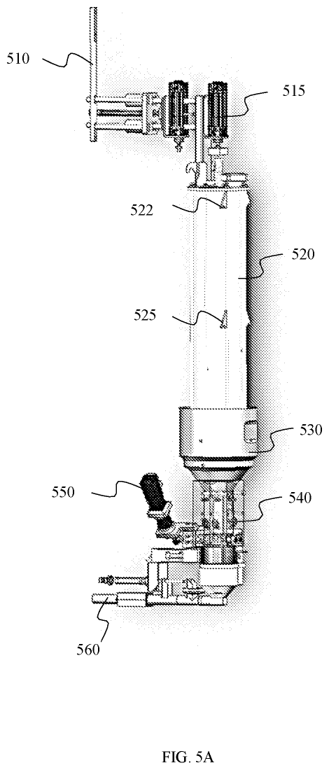

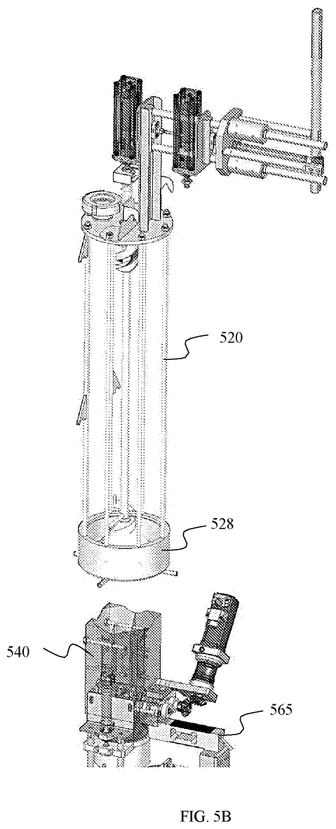

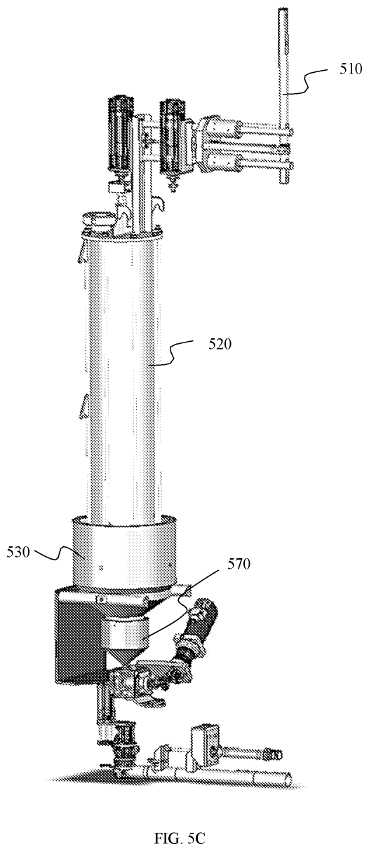

FIGS. 5A-5C schematically show a cartridge body, cartridge seating, and a dispensing head of the autonomous system, according to exemplary embodiments of the present invention.

The cartridge body 520 contains ingredients used to prepare the pizza. The ingredients may be sauces, diced vegetables, fruits, cheese, meat, fish, seasoning, and the like. The ingredients contained in the cartridge body 520 are transferred to a dispensing head 540 upon request to pour the ingredients. Each ingredient is stored in a separate cartridge body 520. The cartridge body 520 is mounted on a cartridge seating 530, the cartridge seating 530 is coupled to the body of the autonomous system, for example to pole 510. The cartridge body 520 is removable from the cartridge seating 530, for example when the cartridge body 520 is empty or when another cartridge body is required to prepare a pizza. The cartridge body 520 may have protrusions 522, 525, enabling an arm to carry the cartridge body 520 when removing the cartridge body 520 from the makeline area.

When an order is received at the autonomous system to prepare one or more pizzas, the management system determines which ingredients are required to prepare the pizzas. Then, a pusher 515 coupled to the pole 510 of the autonomous system pushes an amount of the ingredients from the cartridge body 520 to the dispensing head 540. The dispensing head pours the ingredients upon a command from the management system. The command may comprise the amount and dispensing rate for dispensing the ingredients. For example, the same amount of ingredients may be dispensed for 15 seconds, or for 45 seconds, depending on the preparation process of the pizza as stored in the system's memory. The robotic arm disclosed above moves the tray under the dispensing head 540 to match the pouring process, and to pour the ingredients according to the preparation process of the pizza. The dispensing head 540 may be coupled to a dispensing head actuator 550 which moves a component in the dispensing head 540 in order to pour the ingredients. The component may be a cogwheel or an element blocking the flow of liquid from the dispensing head 540. FIG. 5A also shows a drainage pipe 560 used to drain liquids from the dispensing head 540 after cleaning the dispensing head 540.

FIG. 5B shows a cartridge dispenser 528 used to dispense the ingredients from the cartridge body 520 to the dispensing head 540. The cartridge dispenser 528 may be placed in the bottom part of the cartridge body 520. The cartridge dispenser 528 may move rotationally in response to a command to dispense the ingredients to the dispensing head 540. For example, the cartridge dispenser 528 may have teeth defining the rotational movement, for example, one tooth every 30 degrees (12 clicks to complete a circle). The amount of ingredients dispensed to the dispensing head 540 for every “click” is known in the management system. In addition, the amount of ingredients dispensed to the dispensing head 540 for every “click” may vary for each ingredient. For example, every click results in the pouring of 12 grams of diced mushrooms, or 9 grams of diced onions. In an exemplary case, the management system receives an order for a large pizza with mushrooms, which requires 60 grams of mushrooms and 90 grams of onions. Then, the management system sends a command to the cartridge body 520 storing onions to dispense 90 grams, and the cartridge dispenser 528 moves in 10 “clicks” (9 grams per click). The dispensing head 540 is coupled to a weight 565 for weighing the dispensing head 540 to detect the amount of content provided from the cartridge body 520 to the dispensing head 540.

FIG. 5C shows a liquid dispensing head 570 for pouring liquid. The liquid may be sauce, milk, water, ketchup, mayonnaise, mustard, and the like. The liquid dispensing head 570 may have a conic shape, having a narrow end in the bottom part, closer to the pizza, for pouring the liquid in a limited pouring rate. The liquid dispensing head 570 may utilize a pump, for example, a nob pump, for pumping the liquid from the cartridge body 520 to the liquid dispensing head 570.

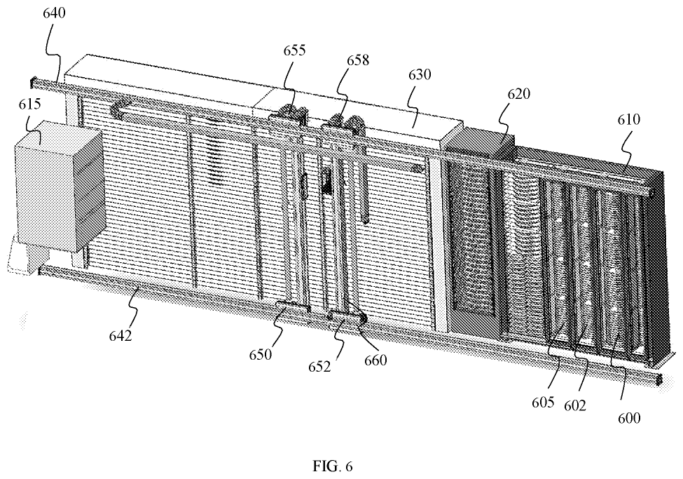

FIG. 6 shows a storage area for storing pizza dough, according to exemplary embodiments of the subject matter.

The dough storage area comprises frozen compartments 610 and cooled compartments 630. The temperature in the frozen compartments 610 may be lower than minus 2 degrees Celsius. The temperature in the cooled compartments 630 may be in the range of 2-6 degrees Celsius. When loading new doughs into the autonomous system, the new doughs are loaded to the frozen compartments 610. The loading may be performed from an external side of the frozen compartments 610, closer to the housing's sidewalls. When moving the doughs from the frozen compartments 610 to the cooled compartments 630, a robotic arm extracts the doughs from an internal side of the frozen compartments 610, opposite to the direction from which the doughs were loaded. That is, the frozen compartments 610 have an external opening and an internal opening. The frozen compartments 610 may be sealed using doors. The doors may be automatically opened when there is a need to load doughs or extract doughs from the frozen compartments 610.

Loading doughs into the frozen compartments 610 may be done in a stack of multiple doughs. The stack may include 2-40 doughs. The doughs in the stack may be separated, for example via shelves. The shelves may be an integral part of the stack or be removable from the stack. The shelves may be coupled to the frozen compartments 610 using grooves or niches or protruding members in the body of the frozen compartments 610.

The frozen compartments 610 may store stacks of various sizes, for example, different pizza sizes or different types of pizza, for example, Gluten-free pizza.

Extracting the doughs from the frozen compartments 610 may be done according to system requirements as to the number of doughs to be ready for the preparation of the pizzas in a given time. For example, in case the system dictates that 100 doughs should be ready for preparation at 14:00, and the doughs are required to spend 18 hours in the cooled compartments 630. In case the cooled compartments 630 store 32 doughs, the robotic arm will extract 68 doughs from the frozen compartments 610. In case a single extraction and load of dough from the frozen compartments 610 to the cooled compartments 630 requires 30 seconds, the transfer process of the doughs may begin 34 minutes before the due time of 14:00. The management system of the autonomous system stores the status of the doughs in the compartments. For example, dough in compartment #13 is ready, dough in compartment #14 will be ready in 2 hours and 46 minutes etc.

Moving a dough from the frozen compartments 610 to the cooled compartments 630 may begin by extracting a plate from a specific compartment of the cooled compartments 630 and placing the plate in a working station. Then, an oiling module may output oil onto the plate. The oiling module may comprise a dispenser movable by the robotic arm. Then, after oiling, the robotic arm extracts a dough and places it on the oiled plate. There may be more than one robotic arm executing the processes disclosed herein. The robotic arm is capable to hold plates of multiple sizes, for example by adjusting a distance between two gripping modules of the robotic arm.

After the doughs are ready and defrosted, the doughs are transferred from the cooled compartments 630 to a dough stretching system 615 in which the dough is stretched prior to baking. Stretching the dough, also known as opening the dough, is a process in which the dough's surface area increases and the dough's height is reduced.

In some cases, the dough storage area comprises a proofer system 620. The proofer system 620 is configured to provide the physical conditions for the dough to swell. For example, the humidity in the proofer system 620 may be higher than 80 percent and the temperature is higher than 25 degrees Celsius.

The dough storage area comprises one or more lateral bars 640, 642, and vertical bar 660. The lateral bars 640, 642 may be coupled to the compartments 610, 620, 630, or to the body of the autonomous system, such as to a ceiling, wall, base of the housing, or another component in the autonomous system. The lateral bars enable movement of the robotic arm on the horizontal axis, for example from the frozen compartments 610 to the cooled compartments 630. The vertical bar 660 may be coupled to an actuator or a motor, enabling the vertical bar 660 to move along the lateral bars 640, 642. In some cases, the robotic arm may be coupled to or be extended from a base, said base is secured to the vertical bar 660.

The vertical bar 660 may comprise sliders enabling the vertical bar 660 to slide along the lateral bars 640, 642. The sliders may cover at least half of the cross-section of the lateral bars 640, 642. For example, sliders 650, 652 enable the vertical bar 660 to slide along lateral bar 640, and sliders 655, 658 enable the vertical bar 660 to slide along lateral bar 642.

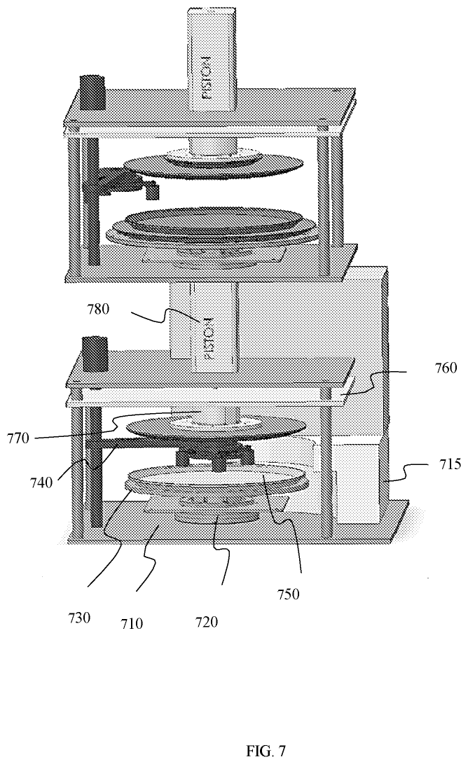

FIG. 7 shows a machine for stretching pizza dough, according to exemplary embodiments of the subject matter. The machine receives dough in a non-stretched form, meaning dough that is not ready for baking pizza in terms of the dough's shape. For example, the dough's shape may be a disk or another shape that is either too high or too narrow. The stretching machine pulls the dough away from an imaginary center, thereby covering a larger area on the plate on which the dough is placed.

An autonomous system of the subject matter may comprise multiple stretching machines, for example, stacked one on top of the other or next to the other. Each of the stretching machines works independently from the others, for example by receiving separate commands from the management system of the autonomous system. Each of the stretching machines is coupled to a power source, such as a battery or power cable.

A stretching machine comprises a body for securing the stretching machine's components. The body may comprise a base 710 placed on the autonomous system's floor or on another surface. The stretching machine comprises a rotating plate 730. The rotating plate 730 rotates around an axis perpendicular to the base 710, or in a manner that keeps the dough in place. The rotation's duration and speed may vary based on the dough's weight or other properties. When stretching the dough, the rotation's speed may vary based on a predefined plan. A plate 750 having the dough is configured to be mounted on top of the rotating plate 730, or on top of a vertical module located on the rotating plate 730.

The stretching machine comprises one or more vertical modules configured to move downwards toward the dough in accordance with the progress of the stretching process. At least some of the movement is done when the dough rotates on the rotating plate 730. The amount and duration of the vertical movement applied by the vertical module 770 may vary during the stretching process of the dough. The vertical module 770 moves downwards towards the plate 750 carrying the dough using an actuator. The vertical module 770 and the vertical actuator may be placed in a vertical housing 780. The stretching machine may comprise multiple vertical modules of various sizes, to be able to move toward doughs of various sizes. In some cases, the bottom part of the vertical modules is different in size and the top part of the vertical modules is the same, enabling to place the plate 750 regardless of the dough's size.

The vertical module 770 may be coupled to a vertical stabilizer 760. The vertical stabilizer 760 is coupled to the body of the stretching machine, for example by sliding along the body's legs, to maintain the vertical stabilizer 760 substantially parallel to the base 710. This way, the vertical module 770 remains parallel to the base 710 and moves toward the dough from a substantially perpendicular angle.

The stretching machine may comprise a machine 715 for preparing the dough to be used for complicated pizza types, such as pizza with cheese filling the parts of the dough closer to the circumference.

The stretching machine may comprise a placing module 740 configured to place the dough in the center of the plate 750. The placing module 740 may comprise movable rollers in a bottom part of the placing module 740. The placing module 740 comprises an arm for moving the rollers towards the plate and away from the plate, as needed. The rollers enable the placing module 740 to verify that the dough is in the center of the plate 750 while the plate rotates on the rotating plate 730.

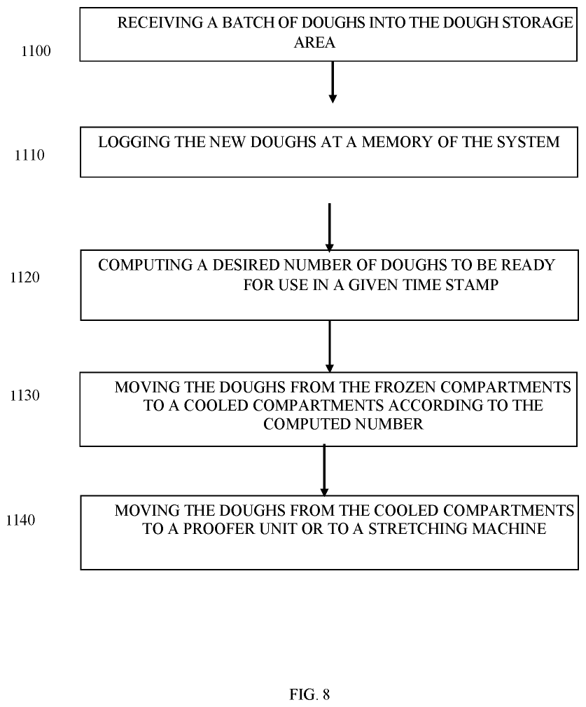

FIG. 8 shows a method for processing doughs in the autonomous system, according to exemplary embodiments of the subject matter. The method may be performed by a robotic arm located in the autonomous system.

Step 1100 discloses receiving a batch of doughs into the dough storage area. The batch of doughs is inputted by a person or by a robot. The doughs may be provided in a non-stretched format, for example in a disc shape. The doughs may be provided as a stack of doughs, each dough is placed in a manner that enables extraction of a single dough. The doughs may be placed in the frozen compartments.

Step 1110 discloses logging the new doughs at a memory of the system. Logging may include the dough type, the dough size, the specific tray in which each dough is placed, or a group of trays for a group of doughs in case the same type of doughs is loaded. Logging also includes the loading time, so the system can monitor the estimated temperature according to the time the dough spends in each compartment, such as frozen, cooled and the like.

Step 1120 discloses computing a desired number of doughs to be ready for use in a given time stamp. The number of doughs may be computed according to a predicted amount of pizzas to be produced by the system in a given time or range of time, for example between 19:00 and 21:00. For example, if there is a predicted demand of 80 pizzas, the management system verifies that there are 80 doughs in the cooled compartments a predefined time duration beforehand.

Step 1130 discloses moving the doughs from the frozen compartments to a cooled compartments according to the computed number. Moving may be performed using a dough moving system configured to move dough between storage compartments, or to the stretching machine, or onto a plate, to the dispensing system, for preparing the pizza. The dough moving system may comprise a robotic arm configured to collect the doughs. The timing of the moving process may be computed by the management unit, according to predicted demand or according to business rules of the system.

Step 1140 discloses moving the doughs from the cooled compartments to a proofer unit or to a stretching machine. Movement out of the cooled compartments may be performed after a minimal time duration that the doughs spent in the cooled compartment. selection of whether to move the defrosted dough to the proofer or to the stretching machine may be done according to an order received at the system or according to a minimal number of proofed doughs in the system.

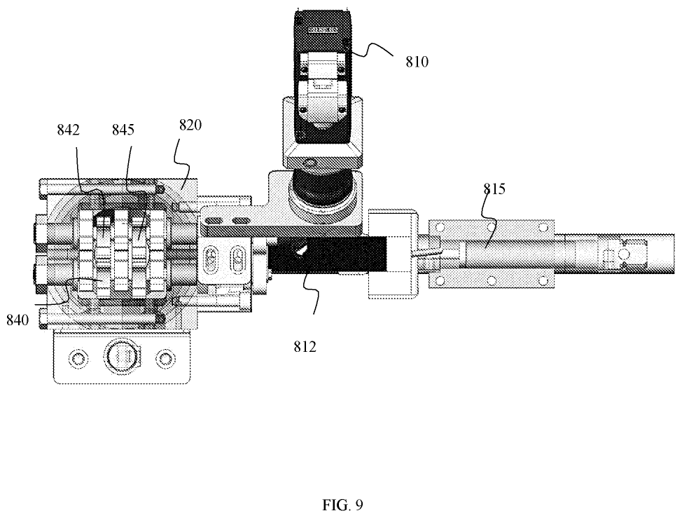

FIG. 9 schematically shows a dispensing unit for dispensing content, according to exemplary embodiments of the present invention. The dispensing unit comprises a dispensing head 820 for pouring the ingredients and a dispensing head actuator 810. The dispensing head 820 is coupled to a drainage pipe 815 for cleaning the dispensing head 820. When preparing a pizza, the dispensing head 820 receives the ingredients from the cartridge body. The ingredients are then placed on cogwheels 840, 842 located inside the dispensing head 820. The bottom part of the cogwheels 840, 842 is located outside the dispensing head 820, such that when the ingredients are located in the bottom part of the cogwheels 840, 842, the ingredients fall downwards from the cogwheels 840, 842 for example, a pizza dough, or onto a plate, a tray and the like. The dispensing head actuator 810 generates movement of the cogwheels 840, 842, for example based on a command from the management system.

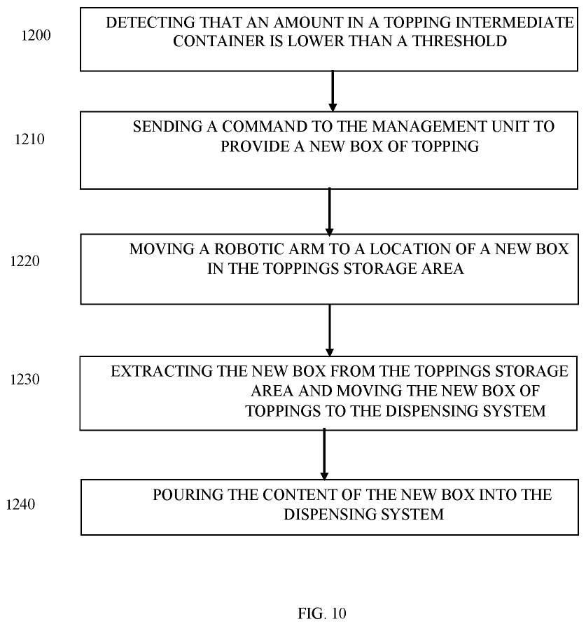

FIG. 10 shows a method for providing a new batch of toppings to the dispensing system, according to exemplary embodiments of the subject matter.

Step 1200 discloses detecting that an amount in a topping intermediate container is lower than a threshold. The detection may be performed using a weight sensor located in the dispensing system. For example, the weight sensor may be implemented as a load cell device. The weight sensor may be placed in the dispensing head or in the intermediate container, depending on the design of the dispensing system. The threshold may differ from one topping to another, and may be configured by a person or by a learning software. the threshold may vary according to predicted demand.

Step 1210 discloses sending a command to the management unit to provide a new box of topping. The command may comprise at least one of an identifier of the topping, an identifier of the container having an amount weighing less than required, an identifier of a new box located in the storage area and comprises the required topping. The new topping may be other than the topping currently stored in the intermediate container that issued the command. dispensing system.

Step 1220 discloses moving a robotic arm to a location of a new box in the toppings storage area. The location of the new box may be computed or determined by a management unit of the autonomous system, or by another controller of processor operating in the autonomous system and capable of communicating with robotic arms in the system.

Step 1230 discloses extracting the new box from the toppings storage area and moving the new box of toppings to the dispensing system. The extraction may be performed using a toppings-moving system. The toppings moving system may comprise a robotic arm or multiple arms. The toppings moving system may comprise grippers for gripping the toppings box. Gripping may be done using magnetic forces or any other technique desired by a person skilled in the art.

Step 1240 discloses pouring the content of the new box into the dispensing system. Pouring may comprise removing a sealing from the new box. Pouring may comprise removing a cover from the container that receives the content of the box. Pouring may comprise tilting the new box towards the receiving container.

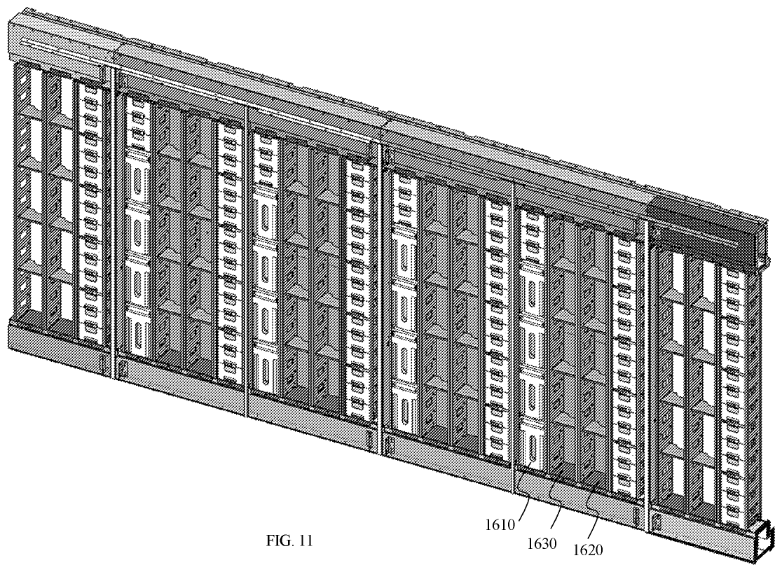

FIG. 11 shows a topping and sauces storage system, according to exemplary embodiments of the subject matter. The toppings are arranged in topping boxes 1620, 1630 in the compartments. The topping boxes 1620, 1630 may be placed in the compartments by a person, such as a delivery person. The topping boxes may have multiple types, sizes and shapes. For example, topping boxes 1620, 1630 carry toppings such as cheese, vegetables and the like, while topping box 1610 carries sausage in a case. When dispensed, the sausage is first separated from the case, and then sliced, as explained below.

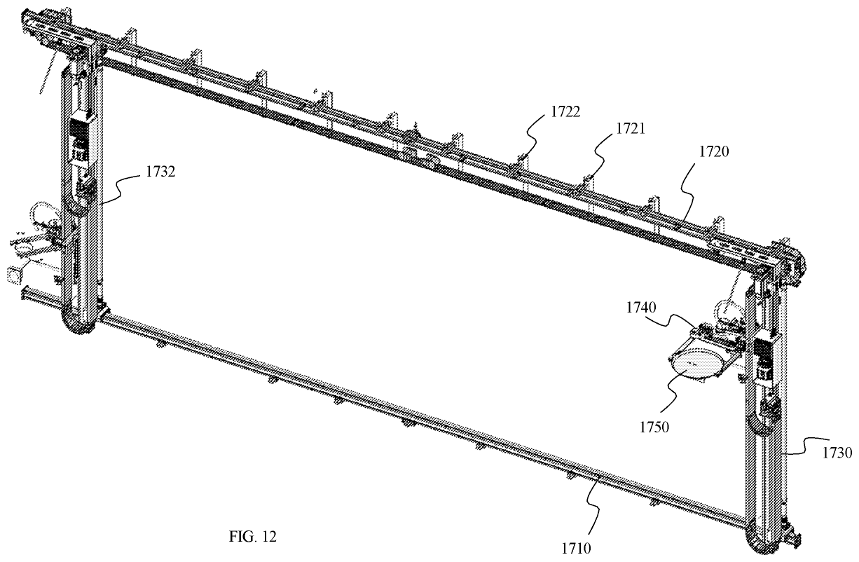

FIG. 12 shows a gantry-like system for extracting content from the topping and sauces storage system, according to exemplary embodiments of the subject matter. The gantry-like system enables a collector to move upwards and downwards along a vertical bar 1730. The vertical bar 1730 may be any bar, or rod, capable of moving upwards and downwards as part of the gantry-like system. The gantry-like system may comprise multiple vertical bars 1730, 1732, according to the system's requirements. The vertical bars 1730, 1732 may move on a horizontal axis along horizontal bars 1710 and 1720. The horizontal bars 1710 and 1720 may comprise stops, such as stops 1721, 1722, that facilitate positioning the vertical bar 1730 and 1732 along the bars 1710, 1720. The collector may comprise a tray 1750 used to carry a box extracted from the topping and sauces storage system and a tray holder 1740 configured to secure the tray 1750 to the vertical bar 1730.

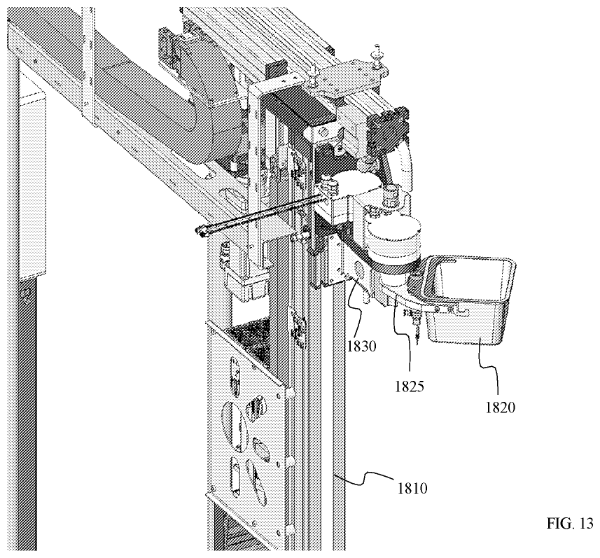

FIG. 13 shows a collector for extracting content from the topping and sauces storage system, according to exemplary embodiments of the subject matter. The topping and sauces storage system may include three types of content-liquids, such as sauces and cream, logs that are required to be sliced before dispensing and chopped or crushed toppings. The toppings may be supplied in a cooled state or a frozen state. The toppings may include sausages, logs of edible content, chopped vegetables and the like. The collector is configured to be coupled to a vertical bar 1810, enabling the collector to move upwards and downwards. The collector is configured to grip a box 1820 using a gripper 1825. In some cases, the gripper 1825 is designed to match with niches, grooves or protrusions in the box 1820. The collector also comprises a gripper connector 1830 configured to move the gripper 1825 relative to the vertical bar 1810. After the box 1820 is collected from the sauces storage system, the box 1820 is placed at the toppings dispensing station. The gripper 1825 may be coupled to the vertical bar 1810 using a SCARA mechanism that moves along the vertical bar 1810. The vertical bar 1810 is part of the gantry-like system. The SCARA may have two joints that enable movement in X and Z plains, and a gripper 1825. The SCARA stands for Selective Compliance Assembly Robot Arm or Selective Compliance Articulated Robot Arm. Scara is a type of an industrial robot. The SCARA robot is most commonly used for pick-and-place or assembly operations where high speed and high accuracy is required. The scara is an exemplary embodiment of a robotic arm configured to move objects from one place to another.

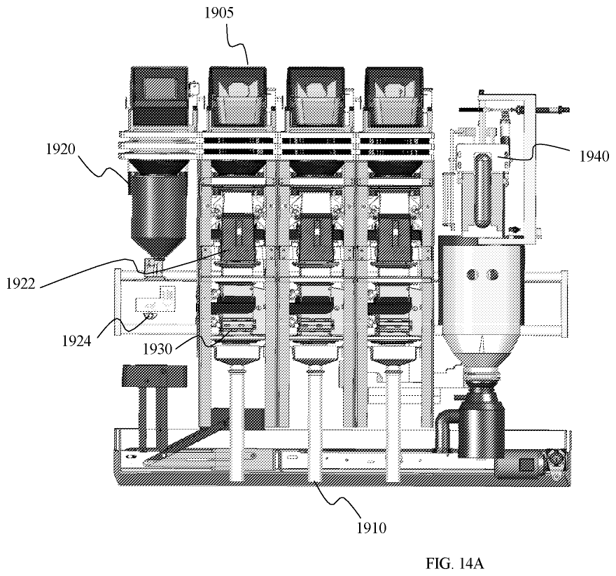

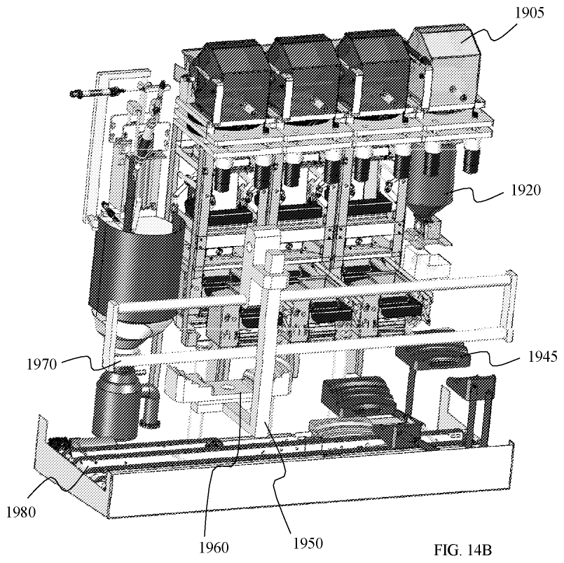

FIGS. 14A-14B show a dispensing system for dispensing toppings and sauces onto the dough, according to exemplary embodiments of the subject matter. The toppings may be vegetables, cremes, diced meat or fish, and the like. The toppings may be sliced or may be crushed, or otherwise cut or separated into small pieces that fit an outlet of the dispenser head.

The dispensing station comprises multiple box storage units, such as box storage 1905 for placing the box that contains the toppings, for example, a box such as the box 1820 transferred from the topping and sauces storage system. The box storage 1905 carries the box when the box undergoes the initial processing, said initial processing comprises removing a part of the package to enable the topping to flow from the box. The box storage 1905 may comprise a valve that controls the flow of the toppings from the box storage 1905 to an intermediate container. The box storage 1905 further comprises mechanisms for removing the empty boxes, such as a robotic arm that moves the empty boxes to a box collection station.

The dispensing station comprises a cleaning system 1910 for the dispenser heads 1924, 1930. The cleaning system 1910 is coupled to a liquid tank, such as water, or to a fluid tank, such as pressurized gas. The pressurized gas or liquid is dispensed toward the dispenser heads to clean the dispensing station. The dispenser heads 1924, 1930 move between at least two positions. In a cleaning position, the dispenser heads 1924, 1930 are placed on the pipes of the cleaning system 1910. In the dispensing position, the dispenser heads 1924, 1930 are placed above a dispensing area, the plate and the dough are placed at the dispensing area. In some other cases, the pipes of the cleaning system can move towards the dispenser heads 1924, 1930 when there is a need to clean the dispenser heads 1924, 1930 and move away from the dispenser heads 1924, 1930 when the dispenser heads 1924, 1930 dispense the toppings. The cleaning process enables to store different toppings after the former toppings are dispensed. The dispenser heads may comprise a weight sensor configured to detect the amount dispensed onto the dough.

The dispensing station comprises a toppings intermediate container 1922 that stores the toppings after being poured from the box storage 1905. The toppings intermediate container 1922 may comprise mechanisms for grinding the toppings, such as knives and moving arms. The toppings intermediate container 1922 dispenses a certain amount of toppings into the toppings dispensing head 1930, for example in the range of 5-10 grams. The toppings intermediate container 1922 may comprise a weight sensor configured to detect whether or not the weight of toppings in the toppings intermediate container 1922 is lower than a threshold and there is a need for a new box to be loaded from the toppings storage area to the dispensing system.

The dispensing station comprises toppings dispensing head 1930 configured to dispense the goods onto the dough. The toppings dispensing head 1930 comprises mechanisms, for example, cogwheels, that enable slow dispensing of the toppings, that match to the movement of the plate that carries the dough, using the plate base 1960 and the plate slider 1950. The toppings dispensing head 1930 may be placed directly under the toppings intermediate container 1922.

In some cases, the dispensing station comprises a sauce intermediate container 1920 for storing the liquid and a sauce dispensing head 1924 located under the sauce intermediate container 1920. The sauce dispensing head 1924 comprises an outlet for dispensing the sauce, and an actuator for moving the sauce dispensing head 1924 in a circular manner around the outlet, to distribute the sauce on the dough.

In some cases, the dispensing station comprises sausage gripper 1940 configured to grip the sausage when the sausage is in the package. In response to a command, for example from the system's management unit, the sausage gripper 1940 places the sausage in the sausage holder, later to be dispensed onto the dough.

In some cases, the dispensing station comprises a plate base 1960 configured to carry the plate when the dispensing heads dispense the toppings and/or sauces onto the dough. The plate base 1960 may be configured to carry multiple sizes of plates. The plate base 1960 may be coupled to an actuator configured to move the plate base 1960 in a circular manner, enabling better distribution of the toppings on the dough.

In some cases, the dispensing station comprises vertical bar 1970 used by a plate slider 1950 to move the plate between the dispensing heads. The vertical bar moves horizontally, or laterally, among the areas under the dispensing heads. The plate slider 1950 is coupled to the plate base 1960, such that the plate moves circularly when the plate slider 1950 moves horizontally. The movement of the plate slider 1950 among the areas under the dispensing heads is synchronized with the movement of the dispensing heads to the dispensing position. That is, the plate slider 1950 moves the plate to dispensing head #3 which dispenses the sauce, and then to dispensing head #6 which dispenses olives.

In some cases, the dispensing station comprises a stand 1945 for the plates. A robotic arm may place the plates with the dough on the stand 1945 and another arm moves the plates from the stand 1945 to the plate base 1960.

In some cases, the dispensing system comprises a plate conveyor 1980 configured for conveying the plates in the dispensing station, or from the dispensing station to another station of the system, for example, the cooking station, after all the toppings are dispensed on the dough located on the plate.

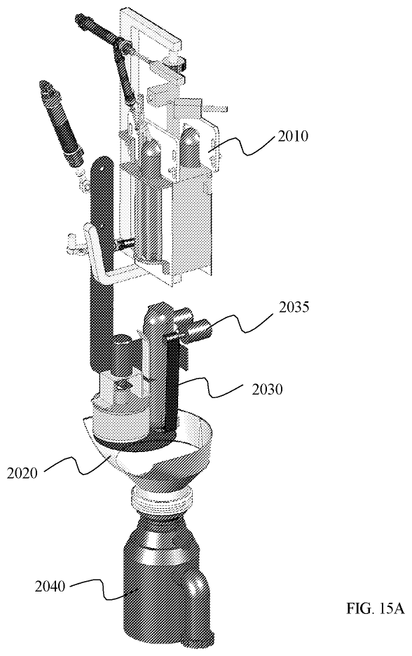

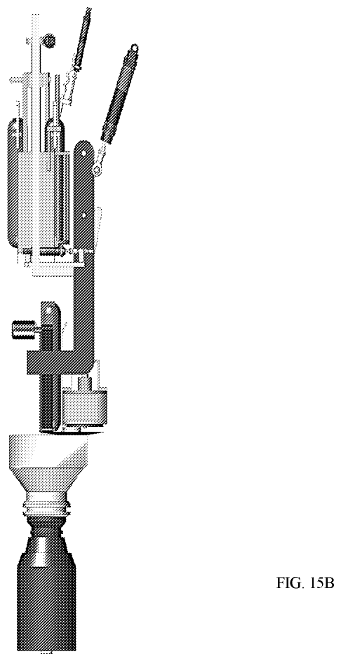

FIGS. 15A-15B show a dispensing system for dispensing sliced content, according to exemplary embodiments of the subject matter. The description below refers to sausages just for simplicity, as the sliced content may be sausages, cheese, vegetables or other edible items that are sliced in the dispensing system before being dispensed onto the dough.

The sliced dispensing system comprises a content holder 2010 that may be a sausage holder. The content holder 2010 is configured to carry the content as received from the topping and sauces storage system. The content holder 2010 may comprise a knife or another mechanism for removing a package from the content before the content is sliced. The content holder may comprise arms or other mechanisms configured to carry the package in which the content is provided when transferred from the topping and sauces storage system.

The sliced dispensing system comprises a slicer 2020 configured to slice the content. The slicer 2020 is coupled to a slicer actuator configured to move the slicer against the content. The speed of the slicer 2020 moving against the content may dictate the sizes of the content dispensed on the dough. Hence, when there is a need for a certain size of slices, the system's management unit sends a control signal to the slicer actuator that moves the slicer 2020 in a manner that matches the desired size.

The sliced dispensing system comprises a sausage gripper 2030 configured to grip the sausage when the sausage is ready to be dispensed. The sausage gripper 2030 is located above the slicer 2020, and moves the sausage downwards to enable the slicer 2020 to keep slicing more slices of the sausage, in case the slicer 2020 does not move upwards and downwards.

The sliced dispensing system may comprise movable straps or poles, as the sausage is configured to be gripped between the straps or poles. The straps or poles may move one relative to the other, thereby capable of gripping contents of various sizes and shapes.

The sliced dispensing system comprises a sausage gripper actuator 2035 configured to move the sausage gripper 2030 in a manner that moves the sausage downwards, towards the slicer.

The sliced dispensing system also comprises an outlet 2040 for storing the sliced content and dispensing the sliced content. The outlet 2040 may be located under the sausage gripper 2030, and coupled to the dispensing system's body.

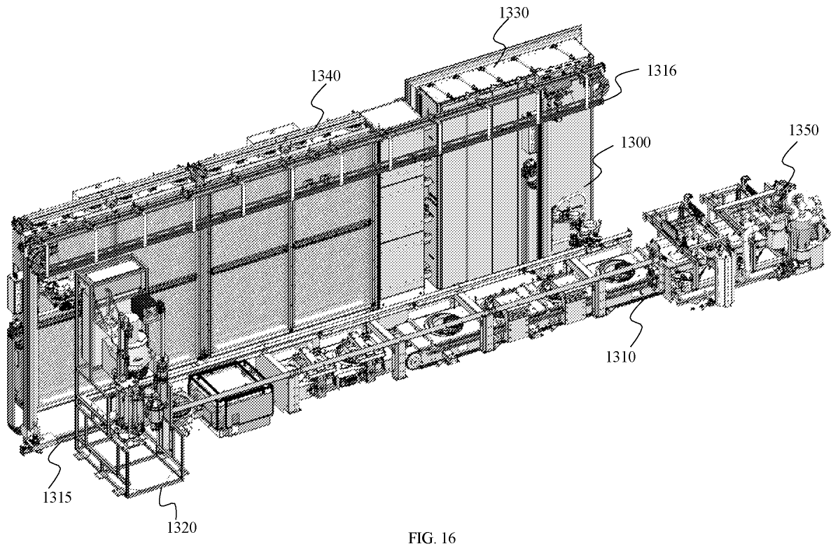

FIG. 16 shows a system for transferring plates from an area in which the pizza is already prepared to the pizza preparation area, according to exemplary embodiments of the subject matter. In some cases, the area in which the pizza is prepared is on another side of the ovens used to prepare the pizza. The area in which the pizza is prepared includes the packing devices and the QA process. The plates move back to the pizza preparation area, that includes the dough storage area, in which dough in the cooled compartments can be extracted and placed on the plates. This way, the same plates are used multiple times, each time the plate carries a new dough. The dough gantry receives the plates that arrive at the conveyor belt and places the plate in place, such as a plate refrigerator when the plates are stored until used in a new cooking cycle.

The system for transferring plates has a distal end 1350 in the area in which the pizza is already prepared. A robot places the plate in the distal end 1350 of the system for transferring plates. The plate moves along a conveyor to a dough storage area 1320. The dough storage area 1320 carries the plate that moved from the distal end 1350 and places a dough from the dough storage onto the plate. The dough, placed on the plate, is then transferred to a makeline area in which sauces and toppings are dispensed on the dough.

The dough storage comprises frozen compartments 1330 configured to store the dough in a frozen state and cooled compartments 1340 configured to store the dough in a cooled state. The dough storage is further coupled to upper bar 1316 and lower bar 1315 that enable safe horizontal movement of the dough extractor station 1320 to a desired location on the dough storage area. The dough storage area 1320 may comprise a lift enabling an extractor to move upwards and downwards to a desired compartment in the dough storage.

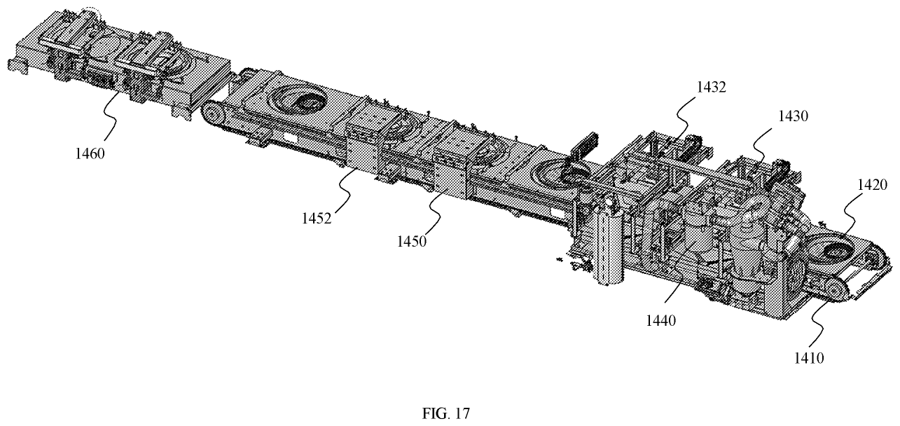

FIG. 17 shows a system for transferring plates from an area in which the pizza is prepared to the pizza preparation area, according to exemplary embodiments of the subject matter. The system for transferring plates comprises a conveyor belt operated by movement of wheels, such as wheels 1410. The system for transferring plates comprises an inlet station 1420 configured to enable a robot to place a plate thereon. The inlet station 1420 may have a niche or another type of design configured to secure a plate. The system for transferring plates comprises cleaning stations 1430, 1432 for cleaning the plates. Cleaning may include dispensing air, gas, liquids, and moving arms or other objects configured to remove edible content left on the plate, such as pizza crumbs, leftovers of toppings or sauce, and the like.

The system for transferring plates may comprise multiple stations for carrying the plates. This way, one of the stations functions as the inlet station 1420, and then moves under the cleaning station 1430. Then, when the plate is clean, the station that carries the plate moves toward the dough extractor station. In some cases, each of the stations can carry a variety of plates sizes, as elaborated below. The system for transferring plates may comprise one or more stations for dispensing content onto the plates. For example, stations 1450, 1452 and 1460 may be configured to output oil onto the plates.

The system for transferring plates enable using the same plates for preparing multiple pizzas, such that after every cycle the plates are collected by a robotic arm and placed on a station of the system for transferring plates. Then, the used plate goes through a cleaning process and conveyed to a cabinet where the plate waits for a new cycle of pizza preparation. When the management system determines that a specific plate is to be used, a robotic arm extracts the specific plate from the cabinet and uses the specific plate during the pizza preparation process. The plate may undergo additional processes, such as oiling the plate and other processes desired by a person skilled in the art.

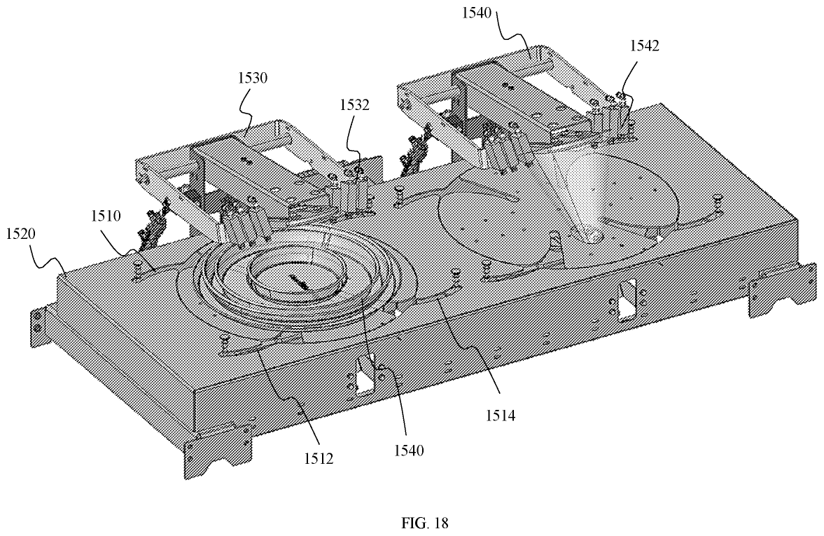

FIG. 18 shows a system for dispensing oil onto the plates in an autonomous pizza preparation system, according to exemplary embodiments of the subject matter. The system is placed on top of a plate carrying station having an upper surface 1520 on which the plate is placed. The station comprises multiple movable arms 1510, 1512, 1514, 1516 that move towards the plate, such that the movement stops when the arms 1510, 1512, 1514, 1516 are in physical contact with the plate. This way, the arms 1510, 1512, 1514, 1516 are coupled to an actuator, such as a motor or a piston. The arms 1510, 1512, 1514, 1516 may move synchronously, for example in case the plate is configured to be placed at substantially equal distances from all the arms 1510, 1512, 1514, 1516. The arms 1510, 1512, 1514, 1516 may move in a lateral movement or a circular movement, for example around an axis.

The system may comprise multiple cleaning systems, for example systems 1530 and 1540, such that multiple plates can be cleaned concurrently. The cleaning systems 1530 and 1540 comprise dispensers 1532, 1542, respectively, for dispensing oil or other formulas, as desired by a person skilled in the art.

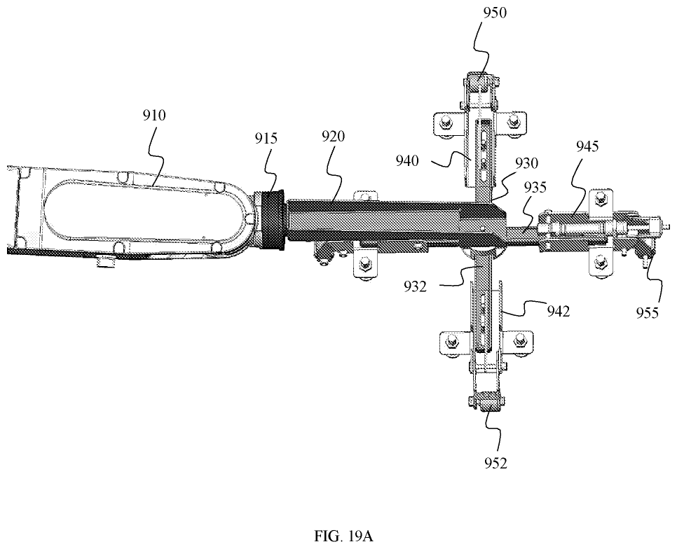

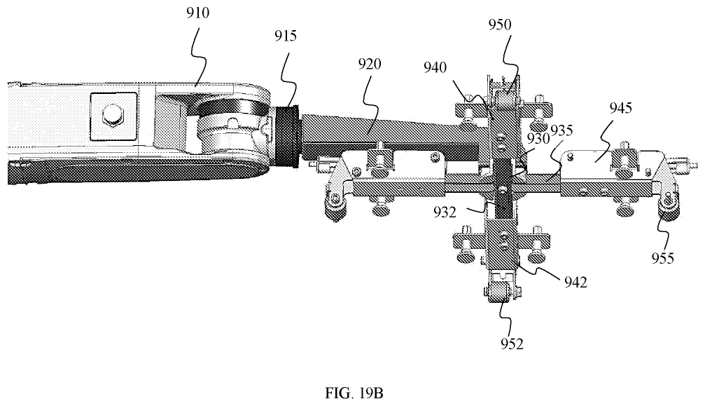

FIGS. 19A-19B schematically show a folding arm for folding a package of a prepared pizza, according to exemplary embodiments of the present invention. The package may be made of cardboard, or from another foldable material, such as woven or non-woven fabric, paper, recycled paper, and the like. The packages are stacked in the autonomous system in a flat position, and the folding arm is used to fold the package around the prepared pizza. Then, the packed prepared pizza is sent to the collection compartments.

The folding arm comprises a connector 910. The connector 910 may connect the folding arm to a robotic arm used to move the folding arm. The folding arm also comprises a main arm 920 coupled to the connector via a hinge 915. The hinge 915 enables to move the main arm in a rotational movement relative to the connector 910. The main arm 920 is coupled to additional three arms 930, 932, 935. Each of the main arm 920 and the additional three arms 930, 932, 935 have a folding member for folding a part of the package. For example, arm 930 comprises folding part 950, arm 932 comprises folding part 952 and arm 935 comprises folding part 955. The arm 1935 may extend from the main arm 920, while the arms 930 and 935 are perpendicular to the main arm 920. This way, the folding arm is capable to fold packages of a rectangular shape. The arms 930, 932, 935 may comprise an adjustable member sliding on the arms. For example, arm 930 comprises adjustable member 940, arm 932 comprises adjustable member 942 and arm 935 comprises adjustable member 945. Each of the adjustable members 1940, 1942, 1945 is coupled to one of the folding parts 950, 952, 955. This way, the distance between folding parts 950, 952, 955 is adjustable, enabling the folding arm to fold packages of various sizes.

The autonomous system comprises an adhesive material emitter for emitting adhesive materials used to fold the package. For example, the adhesive material emitter may emit adhesives when the main arm 920 moves a package towards the adhesive material emitter. The adhesive material emitter may be coupled to the management unit, for receiving commands as to when to emit the adhesives. The adhesive material emitter may comprise multiple dispensing heads, each dispensing head is configured to emit adhesives separately. This way, the foldable package can be folded and closed using adhesives.

Once the pizza is packed, the packed pizza undergoes a quality assurance process. The QA process may comprise a metal detector, that detects whether or not the packed pizza contains metals.

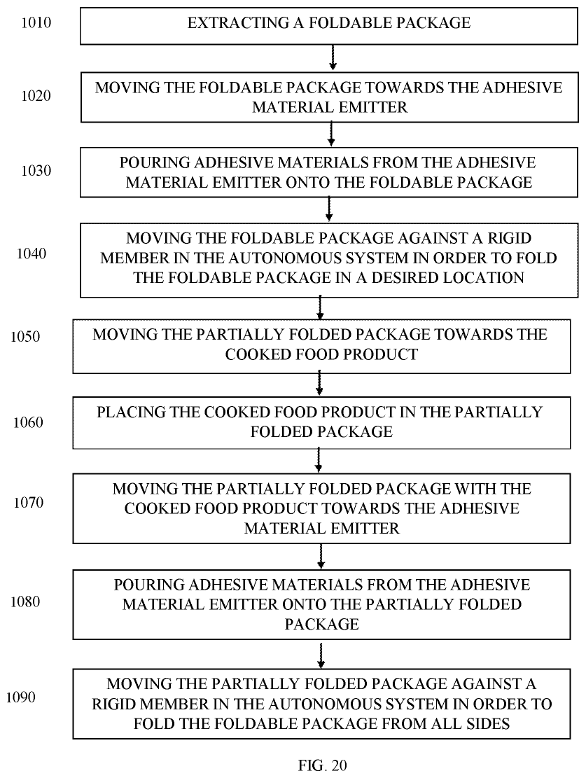

FIG. 20 shows a method for folding a package, according to exemplary embodiments of the subject matter. The method is performed by a folding station located in the autonomous system, for example using a gripper configured to grip the package and move the package.

Step 1010 discloses extracting a foldable package. The foldable package may be placed on top of a stack of foldable packages in the autonomous system. The foldable package may be made from cardboard, wood, plastics, paper, recycled paper, polyethylene, any type of rigid polymer, and the like.

Step 1020 discloses moving the foldable towards the adhesive material emitter. The gripper grips the foldable package, for example in holes, niches, or corners of the foldable package, and brings the foldable package to a specific location relative to the adhesive material emitter.

Step 1030 discloses pouring adhesive materials from the adhesive material emitter onto the foldable package. The adhesive material may be dispensed in a manner sufficient to close the foldable package.

Step 1040 discloses moving the foldable package against a rigid member in the autonomous system in order to fold the foldable package in a desired location. After folding, the foldable package is partially closed, for example from 3 lateral sides out of 4.

Step 1050 discloses moving the partially folded package towards the cooked pizza.

Step 1060 discloses placing the cooked pizza in the partially folded package. This may be done using a gripper that grasps the cooked food product and moves the cooked foo pizza into an opening in the partially folded package. After folding the first part of the package, the gripper moves the package near the table that carries the cooked pizza. The cooked pizza is then pushed or slid into the partially folded package using an arm or another moving member. Then, the partially folded package, with the cooked pizza, is moved to the adhesive station for the second folding process.

Step 1070 discloses moving the partially folded package with the cooked pizza towards the adhesive material emitter. This time, the gripper brings the open side of the partially folded package closer to the adhesive material emitter.

Step 1080 discloses pouring adhesive materials from the adhesive material emitter onto the partially folded package. The adhesive material may be dispensed in a manner sufficient to close the foldable package.

Step 1090 discloses moving the partially folded package against a rigid member in the autonomous system in order to fold the foldable package from all sides.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for preparing pizza, comprising:
a dough storing section configured to store dough to be used for preparing the pizza;
a management system configured to manage the storage and preparation processes of the dough in the dough storing section;
a stretching machine for stretching the pizza dough;
a dough moving system configured to move the dough from the dough storing section to the stretching machine;
a topping-storing section configured to store toppings to be dispensed on the dough;
a dispensing system configured to dispense toppings on the dough;
topping moving system configured to move toppings from the topping storing section to the dispensing system;
one or more collection compartments for storing the pizza after the pizza is prepared for delivery.

2. The system of claim 1, wherein the dough storing section comprises a compartment for frozen dough and a compartment for chilled dough.

3. The system of claim 2, wherein the dough storing section comprises a compartment for proofing the dough.

4. The system of claim 1, further comprises a dough extracting system configured to enable a dough extractor to open a specific compartment in the dough-storing section.

5. The system of claim 1, further comprises a topping extracting system configured to enable a topping extractor to open a specific compartment in the topping-storing section.

6. The system of claim 1, further comprises a dispenser actuator configured to grip the plate and to move the plate that carries the dough when the plate is located under the topping dispenser.

7. The system of claim 1, further comprises a plate conveyor for conveying the plate to the plate-removing unit.

8. The system of claim 1, further comprises a plate cleaning station for cleaning the plate.

9. The system of claim 8, wherein the plate cleaning station is configured to clean the plate when located on a plate conveyor.

10. The system of claim 8, wherein the plate cleaning station comprises a brush and a pressurized gas dispenser.

11. The system of claim 8, wherein the plate cleaning station comprises arms for centering plates of various sizes

12. The system of claim 1, further comprises a packing arm configured for collecting a pizza package from a stack of pizza packages, partially folding the pizza package, placing the pizza in a package, and fully folding the pizza package with the pizza inside the pizza package.

13. The system of claim 1, wherein the dispensing system comprises multiple dispensing heads, each of the dispensing heads comprises an outlet for dispensing the toppings and an inlet for receiving the toppings.

14. The system of claim 13, further comprises cleaning tubes configured to emit fluids into the dispensing heads, said fluids are used to clean the dispensing heads.

15. The system of claim 14, further comprises an actuator for moving the dispensing heads away from the cleaning tubes.

16. The system of claim 13, wherein at least one dispensing head of the multiple dispensing heads is configured to dispense sliced toppings, wherein the dispensing system further comprises a topping slicer coupled to the at least one dispensing head for cutting the sliced topping when the sliced topping is placed at the at least one dispensing head.

17. The system of claim 13, further comprises multiple box storages for receiving content from a box collected from the topping-storing section, wherein each box storage is fluidly coupled to one of the multiple dispensing heads, such that content is transferred from the box storages to the dispensing heads.

18. The system of claim 13, wherein the dispensing system comprises a dispensing weight sensor configured to detect a weight of a topping in a dispensing head and verify the amount of topping dispensed onto the dough.

19. The system of claim 1, wherein the stretching machine is configured to prepare the dough in a form of complicated pizza types.

20. The system of claim 1, wherein the dispensing system comprises a topping weight sensor configured to detect a weight of a topping in a container and electronic circuitry configured to send a command to the topping conveyor to convey a new batch of toppings when the weight is lower than a threshold.

21. The system of claim 1, further comprises a delivery preparation system for preparing the pizza for delivery.

22. The system of claim 21, wherein the delivery preparation system receives the pizza after preparation by cooking equipment, and prepares the pizza for delivery, before sending the pizza to the collection compartments.

23. The system of claim 21, wherein the delivery preparation system comprises a knife for cutting the pizza.

24. The system of claim 21, wherein the delivery preparation system comprises a bundling arm for packing multiple pizzas in a single package.
